(19) United States
(12) Patent Application Publication
(10) Pub. No.: US 2016/0328496 A1
(43) Pub. Date: Nov. 10, 2016

(54) SYSTEM AND METHOD FOR EDITING A MODEL

(71) Applicant: Siemens Product Lifecycle Management Software Inc., Plano, TX (US)

(72) Inventors: Howard Charles Duncan Mattson, Cambridge (GB); Douglas Joseph King, Peterborough (GB); Jeremy Rogers, Cambridge (GB)

(21) Appl. No.: 14/703,295

(22) Filed: May 4, 2015

(51) Int. Cl. G06F 17/50

(52) U.S. Cl. CPC G06F 17/5009

(57) ABSTRACT

Methods for simulating modifications to construction of a part of a multi-part product, or editing a model, corresponding data processing systems and computer readable media. A method of includes identifying one or more regions of interest in the model and separating the one or more regions from the model to form a separated region and a base model. The method includes applying a change to the separated region to form a changed separated region; re-connecting the changed separated region to the base model to form a changed model; and outputting the resulting topology.

### TECHNICAL FIELD

This present disclosure relates to the general field of computer aided design, drafting (“CAD”), manufacturing (“CAM”) and visualisation systems (individually and collectively “CAD systems”), product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved methods and systems are desirable.

### SUMMARY OF THE DISCLOSURE

Various disclosed embodiments include methods for simulating modifications to construction of a part of a multi-part product, or editing a model.

A method includes modelling the product using a variational direct model, selecting one part of the multi-part product for modification and setting criteria for a region of interest within the part. The method includes determining all regions of interest within the model representing the selected part which meet the criteria; extracting the region of interest, or extracting each region of interest, from the model and applying a geometric modification to the extracted region of interest, or to each extracted region of interest, of the part. The method includes re-connecting the geometrically modified region, or each geometrically modified region of interest, to the selected part; and providing a representation of the modified part.

A method includes identifying one or more regions of interest in the model and separating the one or more regions from the model to form a separated region and a base model. The method includes applying a change to the separated region to form a changed separated region; re-connecting the changed separated region to the base model to form a changed model; and outputting the resulting topology.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

An example of method and data processing system according to the present disclosure will now be described with reference to the accompanying drawings in which:

FIGS. 1a to 1c compare the effect of editing using standard direct modelling and the method of the present disclosure;

FIG. 2 shows an example of a part to which the disclosed embodiments may be applied;

FIGS. 3a to 3e show the effect of applying a geometric modification to the part of FIG. 2 using a standard model;

FIGS. 4a to 4e show the effect of applying a geometric modification to the part of FIG. 2 using an embodiment of an exemplary method and data processing system of the present disclosure;

FIGS. 5a and 5b illustrate one embodiment of a method of the present disclosure;

FIG. 6 illustrates a part in more detail in accordance with the disclosed embodiments;

FIG. 7 illustrates a part in more detail in accordance with the disclosed embodiments;

FIG. 8 illustrates a part in more detail in accordance with the disclosed embodiments;

FIG. 9 illustrates a part in more detail in accordance with the disclosed embodiments;

FIG. 10 illustrates an example of applying simplification in an exemplary method in accordance with the disclosed embodiments;

FIG. 11 illustrates an example of applying simplification in an exemplary method in accordance with the disclosed embodiments;

FIGS. 12a and 12b show a part in more detail, in accordance with the disclosed embodiments;

FIG. 13 is a block diagram of a data processing system in which an embodiment can be implemented; and,

FIG. 14 is a flow diagram of a process in accordance with disclosed embodiments.

### DETAILED DESCRIPTION

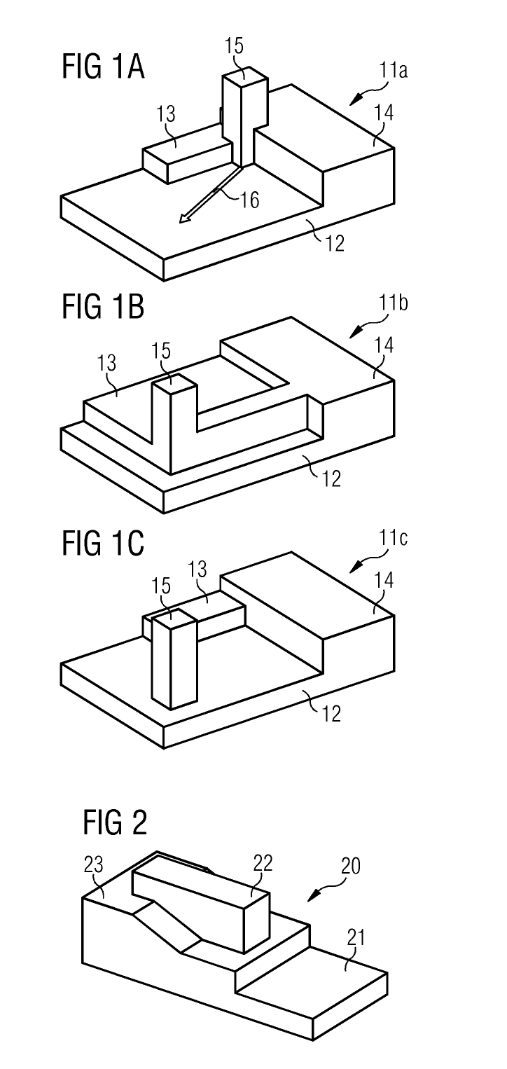

The embodiments of FIGS. 1 to 14 used to describe the principles of the present disclosure in this document are by way of illustration only and should not be construed in any way to limit the scope of the disclosure. Those skilled in the art will understand that the principles of the present disclosure may be implemented in any suitably arranged device, apparatus, system, or method.

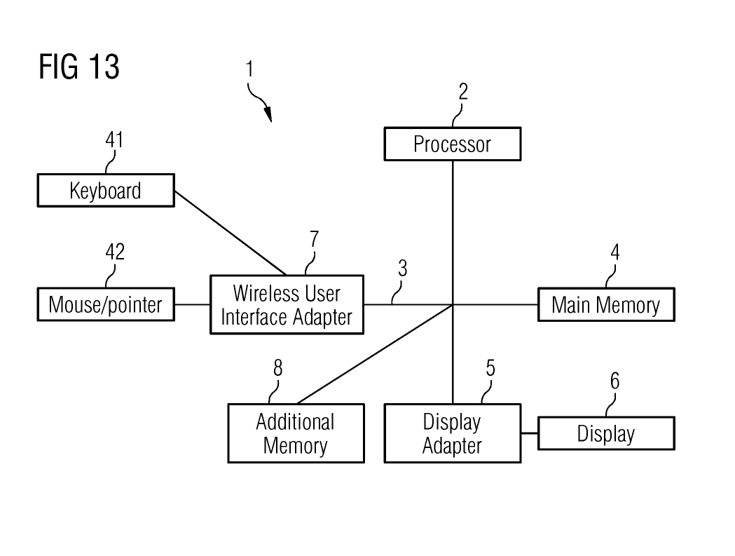

FIG. 13 illustrates an example of a data processing system in which an embodiment of the present disclosure may be implemented, for example a CAD system configured to perform processes as described herein. The data processing system 1 comprises a processor 2 connected to a local system bus 3. The local system bus connects the processor to a main memory 4 and graphics display adaptor 5, which may be connected to a display 6. The data processing system may communicate with other systems via a wireless user interface adapter connected to the local system bus 3, or via a wired network, e.g. to a local area network. Additional memory 8 may also be connected via the local system bus. A suitable adaptor, such as Wireless User Interface Adapter 7, for other peripheral devices, such as a keyboard 41 and mouse 42, or other pointing device, allows the user to provide input to the data processing system. Other peripheral devices may include one or more I/O controllers such as USB controllers, Bluetooth controllers, and/or dedicated audio controllers (connected to speakers and/or microphones). It should also be appreciated that various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further it should be appreciated that many devices referred to as input devices or output devices may both provide inputs and receive outputs of communications with the data processing system. Further it should be appreciated that other peripheral hardware connected to the I/O controllers may include any type of device, machine, or component that is configured to communicate with a data processing system.

An operating system included in the data processing system enables an output from the system to be displayed to the user on display 6 and the user to interact with the system. Examples of operating systems that may be used in a data processing system may include Microsoft Windows™, Linux™, UNIX™, iOS™, and Android™ operating systems.

In addition, it should be appreciated that data processing system 1 may be implemented as in a networked environment, distributed system environment, virtual machines in a virtual machine architecture, and/or cloud environment. For example, the processor 2 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 1 may vary for particular implementations. For example the data processing system 1 in this example may correspond to a computer, workstation, and/or a server. However, it should be appreciated that alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 1 may be connected to the network (not a part of data processing system 1), which can be any public or private data processing system network or combination of networks, as known to those of skill in the art, including the Internet. Data processing system 1 can communicate over the network with one or more other data processing systems such as a server (also not part of the data processing system 1). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

In CAD systems, a user may wish to model a design for an object, carry out tests to determine the behaviour of that object and modify the design in response to the outcome of the tests. At certain stages in the design process, the user may wish to make changes and then revert to the original, if the outcome is not as expected, or to trial a number of different changes in succession to determine which is to be used. However, the user is resistant to activities with long delays.

Direct modelling, or variational direct modelling may be used in any case where an object or article is represented as a solid, including machine parts, vehicles, equipment installations, building layouts, engineering structures, or chemical structures, but the disclosure is not limited to these applications. A three dimensional model allows mass, or weight of parts to be derived and interaction with other components in other systems can be determined In synchronous editing, a geometric change, or geometric modification, is determined by various methods of solving and procedural calculation and then needs to be transferred into the model topology. Until now, the method for doing this was to use direct modelling exclusively on the whole model in situ. A variational direct modelling system describes the parameters of and relationships between features in an object model in terms of geometric constraints and dimensions. Such systems then use a solver process to process these constraints and dimensions, along with a multitude of ancillary constraints and dimensions required to maintain design intent, and the entire model is solved simultaneously.

With conventional direct modelling, editing a design of an object has involved making a modification and updating the whole model in situ. However, this may result in failure of the direct modelling operations, for example, local failures due to particular geometry and topology configurations and the current capabilities of the modeller being used. There may also be combination failures caused by the complexity of trying to concurrently apply many and varied changes to the model. Another problem with making a modification and updating the whole model in situ is that the solution achieved is not the one intended by the user.

FIGS. 1a to 1c illustrate a basic embodiment of the present disclosure. The method may be applied to a model which comprises a representation of any solid object. A model of a part of a more complex body is shown in FIG. 1a, for example a machine part, or a factory layout. The CAD system is able to distinguish all elements of a part, for example by virtue of the part having been originally modelled as a single part. If the user selects only a limited number of faces of the part, the model is able to determine all other elements of the part to which subsequent modelling steps must be applied. The part 11a includes a base 12, a first raised section 13, a second raised section 14 and a topological feature, typically a pocket or protrusion, for which the user wishes to modify the location. In this example, the feature is shown as a protrusion 15, for example an item that must fit into a corresponding opening in another part of the complex body. The user wishes to try relocating the protrusion 15 to a new location on the base 12, using a simple move of the protrusion, as indicated by arrow 16. However, a simple direct model result of the user dragging the protrusion 15 to the alternative location on the base 12 results in a design 11b with an extension of both of the raised sections 13, 14, which were in contact with the protrusion, as shown in FIG. 1b. In the manufactured article, this would add both cost and weight in terms of the additional material used, which is not desirable. The present disclosure avoids this by treating the protrusion 15 as a separate item, extracting and moving only the protrusion, then healing the model to a state that no longer shows the gap where the protrusion was in its initial position. This can be seen in FIG. 1c. The use of material in the finished part 11c, as compared with the design of FIG. 1b, from the direct model, has been reduced and the surfaces are easier to manufacture in the finished product. A corresponding fitting for the protrusion in the other part of the body may then also be designed with a simpler shape than that required by the direct model version of FIG. 1b. The design of the corresponding fitting in the other part of the body may be applied by adapting the shape, or position, of the other part to maintain fit, in conjunction with the changes being made to the originally chosen part, or the adaptation may be applied in a separate step, after the changes to the originally chosen part have been completed.

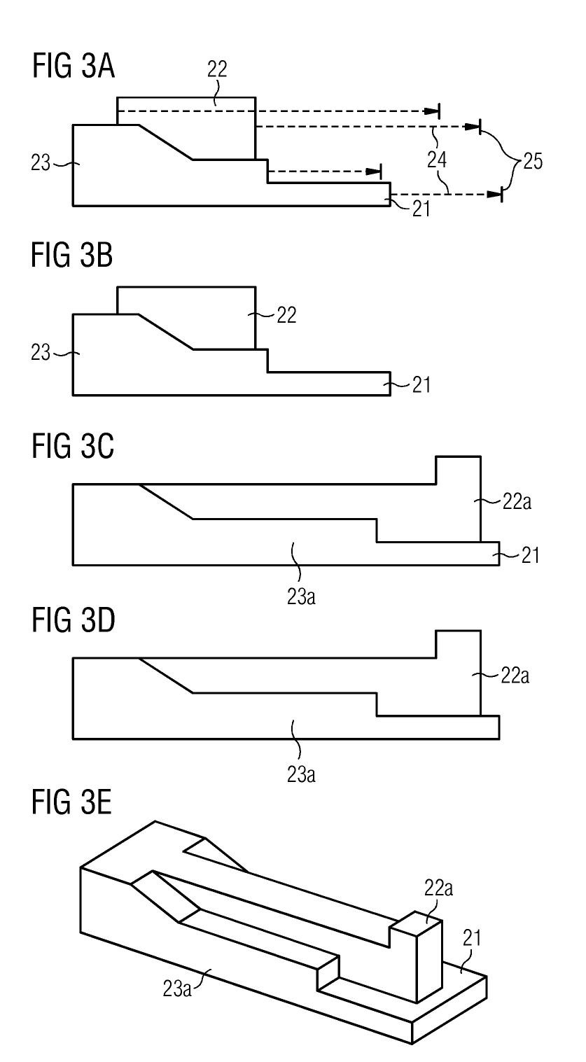

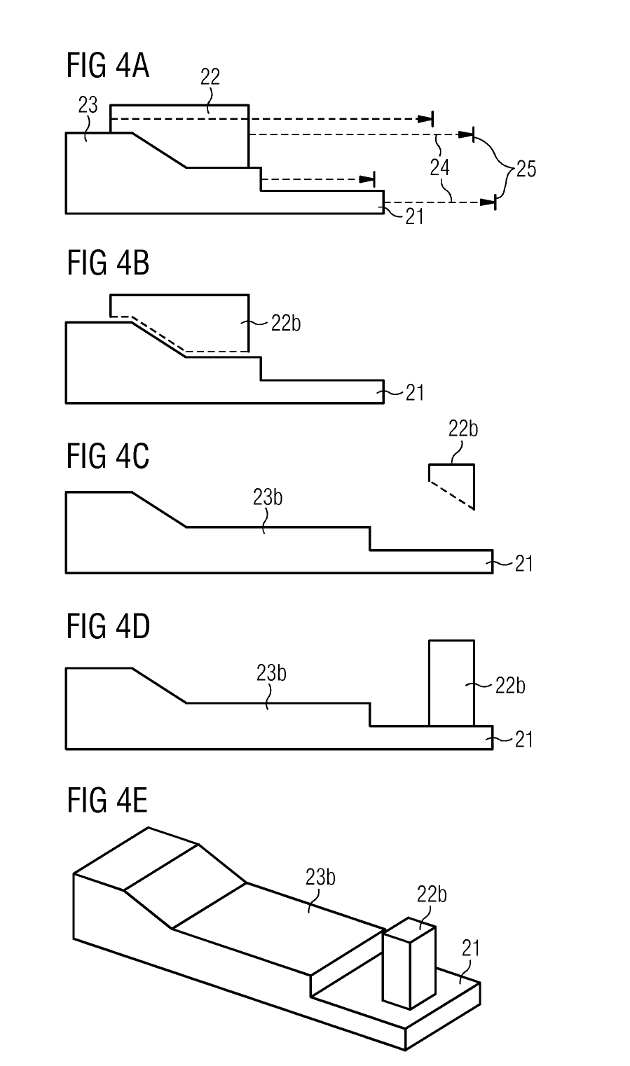

FIGS. 4a to 4e shows another embodiment of the disclosure and compares this with a standard direct model generated design, as shown in FIGS. 3a to 3e, for a part modelled by the data processing system, shown in FIG. 2. For part 20, there is a base 21, contoured section 23 and topographical feature shown by the insert, or protrusion 22. FIGS. 3a and 4a show a geometric expression of the modification required, which is the same modification in both the direct model and the embodiment of the disclosure, i.e. a simultaneous movement of faces by the different amounts shown by the dashed lines 24 to the resulting locations indicated by the solid lines 25 at the end of the dashed lines. More generally, a geometric modification is any direct modelling operation which has the effect of transforming a face. The detail may vary for each face, whether the same operation is applied, or a different operation is applied, but the operation transforms the face. The geometric modification applied to the base model and the geometric modification applied to the separated out regions of interest may be of the same type of operation, or they may be different types of operation. A first step in the present disclosure is to identify topographical features, referred to as regions of interest, to which a change will be applied. In the example shown, there is a single region of interest 22b, but the method may be applied to multiple regions of interest, in which case all candidate regions in the model of the part shown in FIG. 2 are identified. An example of multiple regions of interest is described in more detail with respect to FIGS. 12a and 12b below.

The identified candidate regions are regions that may usefully be separated from the model. Typically, these regions correspond to protrusions, or pockets, having an equal convexity boundary. That is, the identified region is defined by consistent convexity at its boundary with the base model.

All candidate regions are separated from the base model, typically by a cut function. Thus region 22b is separated from the base model. The effect of this on the base model is that all the regions are cut and left open as indicated by the dashed lines on FIGS. 4b and 4c and the base model is healed to a solid as indicated by the filled shape and solid lines of FIG. 4c. A failure of the separation for any reason causes the model to revert to the state it was in before the separation was attempted. The region which failed to separate correctly is then removed from the list of candidate regions of interest.

By contrast, as shown in FIG. 3b, the standard direct modelling method proceeds with a single unchanged model which is then modified by the standard model resulting in an extension of region 22 to form region 22a, along with an corresponding extension of region 23 to form region 23a, as shown in FIG. 3c. Base 21 is modified by extension under regions 22a and 23a. Thus, it can be seen that applying all the geometric changes to faces in the base model has a different result with the standard model in FIGS. 3c and 3d, as compared with exemplary method of one embodiment, shown in FIG. 4d. For the present disclosure, the contoured region 23 has been extended to 23b, as indicated in FIG. 4c. The separated region 22b is modified and after modification, reconnected to the modified base 21, with the resulting shape as shown in FIGS. 4d and 4e. Any direct modelling operators may be deployed in this stage including, but not limited to move, rotate, resize, offset, taper, replace. If there is a failure at this point, the failure causes the overall edit to fail, the model reverts to the original 20 and the region of interest which caused the failure is excluded from further processing.

For those candidate regions of interest which have been successfully separated out, then the desired geometric changes are applied to faces in the separated region, or regions, as indicated by the change in shape from 22b in FIG. 4b to 22b in FIG. 4c. Any direct modelling operators may be deployed in this stage including, but not limited to move, rotate, resize, offset, taper, replace, etc. If failure occurs for any reason, then either the overall edit may fail or the model may revert to the original state and the method is re-run with the failure regions removed from the list.

The changes to the base regions 21, 23 by applying the necessary geometric modification may take place before, or after, or in parallel with the change to the separated region, or regions. In this example, the subsequent step of reconnecting the changed separated regions of interest to the changed base model is illustrated in FIGS. 4d and 4e. Although this example has been described with respect to a change to the base model, applying a geometric modification to the base model is optional and there will be situations where there is no need to change the base model.

The protrusion 22b is joined to base 21 and from FIG. 4e, it can be seen that the contoured section from which the protrusion was extracted has healed back to a solid. Reconnecting the separated regions to the base model may be achieved using a paste step. If the reconnection fails for any reason, then the whole edit may fail and the output reverts to the FIG. 2 model, or regions that fail to reconnect may be removed from the candidate list before the model reverts to the original state, i.e. the FIG. 2 model and the whole process is re-run. In some cases where reconnection fails, the user may be given the option to work with the unconnected model manually.

As is clear from FIGS. 3d and 3e, the standard method does not separate out the regions to be edited in the same way, so application of the required geometric changes results in an extended insert 22a. This is a less desirable outcome, as it increases material usage and weight of the part being designed and may make the design of corresponding parts more complicated. In the standard method, if the process fails, no account is taken of the cause of failure, so an attempt to re-run the process may end up failing again for the same reason as the first failure, whereas in the present disclosure, if a separated region fails to reconnect with the base model, the process can be re-run, but this time treating the region which failed as part of the base model and only separating out regions which have not previously failed to reconnect.

The success rate and resultant quality of editing is improved by the system automatically identifying and separating certain regions of the model based on defined criteria before applying a change to the regions of interest and finally reconnecting them into the whole. Other benefits include, but are not limited to, the identification, separation, modification and reconnection steps to optimise the resulting design.

The basic requirement for a region of interest is that it can be separated from the base model and later reconnected. The choice of suitable regions is therefore dependent on the available separation and reconnection methods as discussed hereinafter. The simplest form of region to choose for this method is a connected protrusion, or pocket, with consistent convexity at its boundary with the model. These may be successfully separated using a simple cut and if required, a heal step, to return the cut region to a solid, as well as a heal step to return to a solid, the section from which the region of interest has been cut. A paste step or local Boolean step may be used to reconnect the separated changed region of interest to the base model.

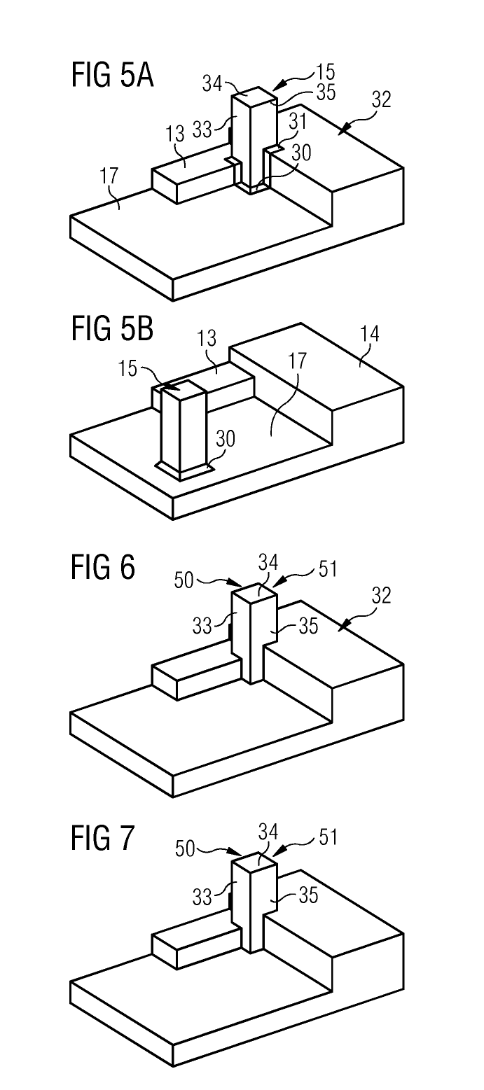

Preferably, treatments, such as blends or chamfers on the boundary of a possible region are ignored when choosing candidate regions. The convexity, for example is considered without any blends. An example with blended regions is illustrated in FIG. 5a and 5b. Blends 30, 31 although present at the boundary of the protrusion 15 in its initial state and after a geometric modification has been applied are discounted in terms of selecting the region of interest and applying the geometric modification to the region.

In its simplest form, the desired geometric feature, such as a protrusion or pocket, which is to be modified, is deemed to be present when the input contains a set of faces that are being changed in the same way (all being moved by the same vector, for example). A check is then made to confirm that the set of faces form a protrusion or pocket by checking that the boundary has single convexity. The boundary consists of all edges where one face is in the set and one is not in the set of faces being considered. If so, that set of faces are designated as a region of interest. In a further step, if the set of faces 32, 33, 34, 35, including hidden faces 50, 51 are not initially confirmed as forming a protrusion or pocket, then a subset of faces may be checked by shrinking back the boundary to consistent convexity, for example as shown in FIG. 6, where face 32 does not form part of the protrusion, but faces 33, 34, 35, 50, 51 do form a protrusion, so the subset 33, 34, 35, 50, 51 is extracted.

Conversely, the addition of a face 34 to a set of changing faces 33, 35, 50, 51 may cause the superset of faces to pass the test, such as shown in FIG. 7. This set of faces may then be used as the region of interest for removal and when applying geometric changes to the separated region of interest, the extra face 34 may get a different change or no change.

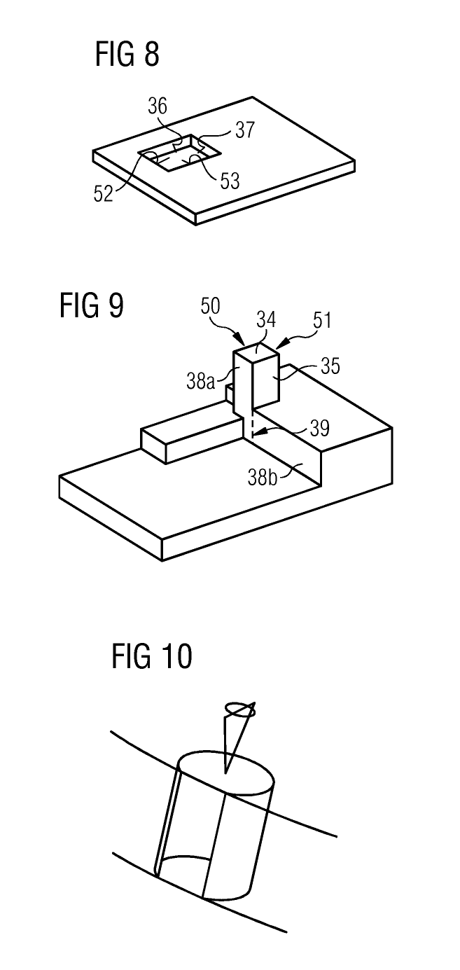

FIG. 8 illustrates an alternative in which a pocket is formed, with multiple boundaries and that pocket may be moved by extracting the faces 36, 37, 52, 53 and applying a geometric modification to them. More generally, a set of changing faces may be examined without regard to the type of geometric change that is to be applied, but the result of the search is a list of areas bounded by the same convexity boundaries.

There is a choice whether to look for maximal or minimal areas when identifying protrusions or pockets. For example, if a portion of a model looks like stacked boxes, then this could be multiple regions of interest in a stack, each with a consistent convexity boundary to the next, or a single region of interest consisting of all the faces. Unless all the faces in the stack are changing in the same way, it is more useful to identify these as separate regions of interest, which are then separated into multiple “region of interest” models.

If a region of interest for extraction cannot be identified according to the constant convexity property, then an option is to split a face with a new edge in order to form a region of interest, as shown in FIG. 9. Faces 34, 35, 50, 51 form part of a set, but face 38a, 38b does not result in the necessary properties because it does not satisfy the requirement for areas to be bounded by the same convexity boundaries. By forming a new edge 39, then only face 38a is included in the set of faces and this then meets the requirements and the set of faces 38a, 34, 35, 50, 51 can be extracted for modification. The new edge will be smooth, either concave or convex in the determination.

A further improvement is to set up the identification of protrusions or pockets on the basis of separation and reconnection methods which are able to handle more complex boundaries, such as mixed convexity. Unchanging faces, may be usefully separated if they interact with changing faces. More direct indicators may be used, such as domain knowledge of specific geometric forms, explicit labelling, user indication or command context in order to suggest that an area to be extracted as a region of interest.

A geometric feature that has nothing to do with the change can be ignored and left in place. However, there may be situations in which initially irrelevant features may become relevant according to the change as they may start to ‘interact’ with changing elements. If it is determined that an initially irrelevant feature does have some interaction with the feature to which the modification is being applied, by examining the other changes as they being applied, then the model may be rolled back to the initial state and new regions added to the algorithm. The process is run again with these regions included.

The basic method for separating and reconnecting regions is to use a standard modelling cut, which disjoins the faces and heals the base model followed by a later paste, similar to a local Boolean operation, leaving a valid solid. As mentioned previously, treatments, such as blends or chamfers on the boundary of a region are handled by storing their properties and reapplying the treatment when reconnecting later in the process—they are not subject to the extraction and modification. The exact geometric form of such treatments that less important, than valid application in the final context, after the geometric modification has been applied to the region of interest.

In some cases, the cut step may not require the base model to heal. This has advantages and disadvantages, although it may improve the success rate of the cut in some cases, failure to heal the base model may hinder the intermediate modification of the unhealed base model. Instead of a cut, a Boolean approach may be used if a closed solid tool is formed from the geometric feature faces plus some capping algorithm to improve the success rate over using a basic cut. When reconnecting, a paste step may be used with an unhealed tool, or else the tool may be extended locally to the base model.

If the geometric feature, or region of interest, corresponds to a domain known object, then there may be a either a known removal/separation procedure and/or a known recreation/reconnection procedure, either of which may be deployed to improve success rate or fidelity. In this case, the recreation procedure incorporates any geometric change required.

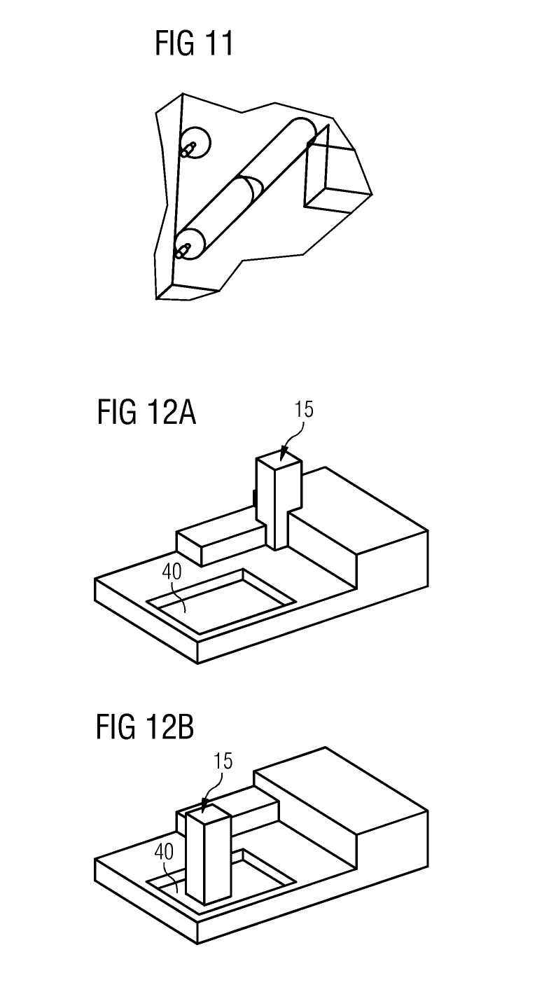

In some cases the separated region has a complex boundary that can be simplified to aid the reconnection process. An example is a hole that touches another feature in the model as shown in FIG. 10. Simplification of this would be to extend the (shaded) cylinder face so that it heals with itself and results in a simple cylinder region with circular edges at each end. Another example is where a single geometric feature has been split when being added to the model. In that case, the two sections may be identified and combined before reconnecting back into the model, for example a split hole, as shown in FIG. 11. The order of removal and reconnection may be specified. For example, with interacting protrusions and pockets, then separating protrusions 15 before pockets 40 and reconnecting pockets before protrusions is preferred, as shown in FIGS. 12a and 12b, to prevent the pocket consuming the protrusion. If the pocket is put back second, the protrusion disappears. Similarly, if stacked features are identified, separation proceeding from the top down and reconnection from the bottom up is preferred, to prevent one feature consuming the other, such as if the bottom box were put back second then the top box would be consumed and disappear.

The example of FIGS. 12a and 12b is one in which more than one region of interest may be processed. As well as the protrusion 15, the pocket 40 is identified as a region of interest and both the protrusion and the pocket are separated out from the base model. A geometric modification is applied to each of the faces in each set of faces defining each region of interest. The modified regions of interest 15, 40 are then reconnected to the base model. In this example, the pocket has been resized and the protrusion has been moved, but other combinations of effects are possible, each region of interest being treated independently. Regions that are ‘involved’ in the change need to be removed, which may vary from a basic selection to more a more complex situation, for example, in which an initially uninvolved region becomes involved as a result of the change applied.

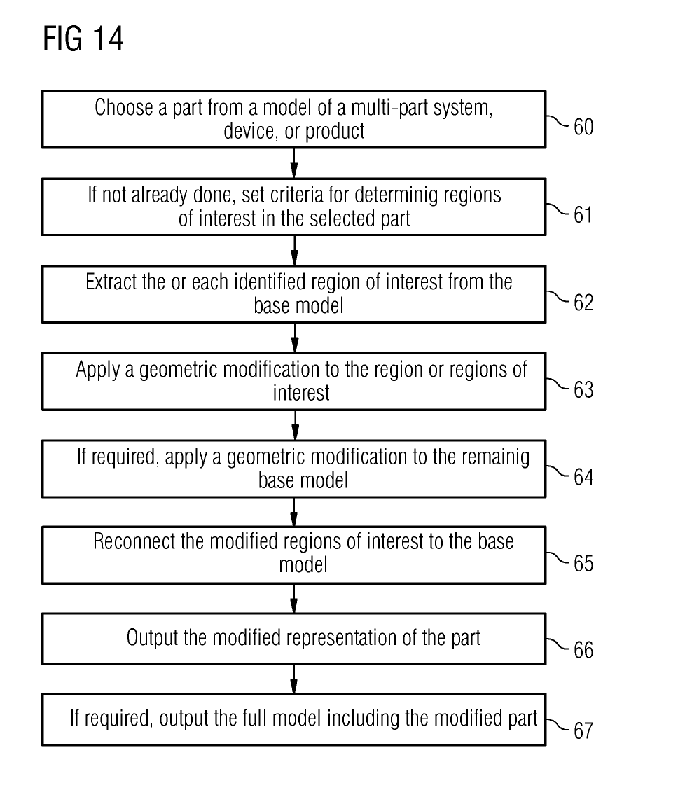

FIG. 14 is a flow diagram summarising one embodiment of a method according to the present disclosure. For a model of a system, device, product, or chemical structure, loaded in a data processing system, the first step 60 is to select a part of that system, device, product or chemical structure which is to be edited—hereinafter referred to as the base model. Having selected the part, then if criteria have not yet been set for selecting regions of interest within that part, the criteria are determined 61. In its simplest form, regions of interest are those in which there are constant convexity boundaries. Using the set criteria, the region of interest or each region of interest is identified and extracted 62 from the base model. A geometric modification, which may have been previously stored, is then applied 63 to the extracted region, or regions of interest. In some cases, it may also be necessary to apply 64 a geometric modification to the base model. Having completed the geometric modification step or steps, the extracted, modified regions of interest are then reconnected 65 with the base model. At this point, typically a modified representation of the part is output 66, which may be as one or both of a display of the modified part, or a step of storing the modified part for future use. Where the modification has an impact on the design or structure of another part of the system, device, product or structure, then an output of the full model, including parts which have not yet been modified may be output 67. The output may comprise storing or displaying the changed model. The basic process may be repeated as required, on different parts, or on the same part until a satisfactory result has been achieved.

The basic method branches only on failure, so there can only be failure or one successful result. However, successful separation and reconnection may be examined for quality and a choice made versus the standard method as to which is better. This choice can be made by displaying both solutions to the user and allowing them to choose. Various graphical methods are available for allowing a user to compare two different results. Alternatively, an automated process for evaluating certain metrics may be used and the system decides which result to use.

The present disclosure has a number of improvements over conventional direct modelling methods. The likelihood of a successful outcome is improved by being able to work on only a subset of the full model and to discount features which cause a failure, but continue with, or restart a run of the process knowing that the cause of the fault has been removed. The quality of the result is improved, for example, in producing a design which minimises material use, or eases design of interacting features in a corresponding part. The process allows for programmatic domain specific control of solution type and specific and different solutions for each local area of a model. The user is still able to choose the solution, whether using the direct model or variational direct model incorporating the present disclosure.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method of simulating modifications to construction of a part of a multi-part product, the method comprising:
modelling the product using a variational direct model;
selecting one part of the multi-part product for modification;
setting criteria for a region of interest within the part;
determining all regions of interest within the model representing the selected part which meet the criteria;
extracting the region of interest, or extracting each region of interest, from the model;
applying a geometric modification to the extracted region of interest, or to each extracted region of interest, of the part;
re-connecting the geometrically modified region of interest, or each geometrically modified region of interest, to the selected part; and
providing a representation of the modified part.

2. A method according to claim 1, wherein the method further comprises applying a geometric modification to the base model.

3. A method according to claim 1, wherein the regions of interest comprise a protrusion or pocket having equal convexity boundaries with the rest of the model.

4. A method according to claim 1, wherein the method further comprises modifying the model representing the selected part in areas outside the regions of interest by repairing open surfaces from which a region of interest has been extracted.

5. A method according to claim 4, wherein the step of repairing comprises forming a continuous surface between edges of the open surfaces.

6. A method according to claim 1, wherein the method further comprises storing a representation of the modified part separately for each region of interest.

7. A method according to claim 1, wherein the method further comprises applying the method to another part of the multi-part product which interacts with the one part.

8. A method according to claim 1, wherein the method further comprises providing a representation of the multi-part product incorporating the modified part or parts.

9. A method according to claim 1, wherein the method further comprises removing treatments from the region of interest before extracting the region from the model and replacing the treatments after reconnecting with the model.

10. A method of editing a model, the method performed on a data processing system, the method comprising:
identifying one or more regions of interest in the model;
separating the one or more regions from the model to form a separated region and a base model;
applying a change to the separated region to form a changed separated region;
re-connecting the changed separated region to the base model to form a changed model; and
outputting the resulting topology.

11. A method according to claim 10, wherein the method further comprises applying a change to the base model.

12. A method according to claim 10, wherein the identifying the region of interest for separation comprises determining the presence of a protrusion or pocket having consistent convexity at its boundary with the model.

13. A method according to claim 10, wherein the method further comprises removing treatments from the region of interest before extracting the region from the model and replacing the treatment after reconnecting with the model.

14. A method according to claim 10, wherein at least one direct modelling operator is applied to the separated region of interest, or to each separated region of interest.

15. A method according to claim 10, wherein the method further comprises identifying one or more base regions of interest and applying at least one direct modelling operator to the base region.

16. A method according to claim 10, wherein the change applied to the one or more base regions of interest heals to a solid any opening left by the separated region of interest.

17. A data processing system having at least a processor and accessible memory, the data processing system configured to:
receive a selected part of a model, the model representing a multi-part product;
identify one or more regions of interest comprising topographical features in the selected part of the model;
extract representations of the one or more regions from the model to form a separated region, or regions;
apply a geometric modification to the separated region to form a modified separated region;
re-connect the modified separated region to the model to form a changed model; and,
output the resulting topology of the selected part.

18. A system according to claim 17, wherein the system comprises a store, or a display configured to output the resulting topology.

19. A non-transitory computer-readable medium encoded with executable instructions that, when executed, cause one or more data processing systems to perform a method of simulating modifications to construction of a part of a multi-part product comprising:
modelling the product using a variational direct model;
selecting one part of the multi-part product for modification;
setting criteria for a region of interest within the part;
determining all regions of interest within the model representing the selected part which meet the criteria;
extracting the region of interest, or extracting each region of interest, from the model;
applying a geometric modification to the extracted region of interest, or to each extracted region of interest, of the part;
re-connecting the geometrically modified region of interest, or each geometrically modified region of interest, to the selected part; and
providing a representation of the modified part.

20. A non-transitory computer-readable medium encoded with executable instructions that, when executed, cause one or more data processing systems to perform a method of editing a model comprising:
identifying one or more regions of interest in the model;
separating the one or more regions from the model to form a separated region and a base model;
applying a change to the separated region to form a changed separated region;
re-connecting the changed separated region to the base model to form a changed model; and
outputting the resulting topology.
